(19) United States
(12) Patent Application Publication
(10) Pub. No.: US 2004/0064913 A1
(43) Pub. Date: Apr. 8, 2004

(54) Deformable grip with motion indicator

(76) Inventor: Boyd I. Willat, Los Angeles, CA (US)

Correspondence Address: Stuart O. Lowry, KELLY BAUERSFELD LOWRY & KELLEY, LLP, Suite 1650, 6320 Canoga Avenue, Woodland Hills, CA, 91367, US

(21) Appl. No.: 10/678,148

(22) Filed: Oct. 2, 2003

Related U.S. Application Data
(60) Provisional application No. 60/415,132, filed on Oct. 2, 2002.

(51) Int. Cl. B43K 3/00

(52) U.S. Cl. 15/443

(57) ABSTRACT

A deformable grip is provided for a manual implement such as a writing implement or a hair brush handle or the like, wherein the grip resiliently conforms to individualized anatomical contours and preferences thereby providing enhanced user comfort with reduced fatigue. The deformable grip includes a resilient transparent outer sleeve mounted for manual grasping during normal implement use, wherein this outer sleeve encloses at least one internal cavity containing a substantially transparent fluid filler material to provide the outer sleeve with a deformable tactile feel. At least one solid or non-fluid body such as a ball or the like is carried within the internal cavity substantially in suspension within the fluid filler material. This non-fluid body is externally visible through the transparent outer sleeve, and movably displaces in response to manual grasping of the implement to visually indicate and confirm shape deformation of the grip.

The application claims the benefit of U.S. Provisional Application No. 60/415,132, filed Oct. 2, 2002.

### BACKGROUND OF THE INVENTION

This invention relates generally to improvements in manually grasped implements such as a writing implement, hair brush, paint brush, sports racquet or bat, hand tool, cooking vessel, as well as virtually any other type of manually grasped device having a handle or related structure for manual grasping. More specifically, this invention relates to an improved deformable grip responsive to user hand and/or fingertip pressure or the like to assume a highly comfortable and low fatigue geometric configuration, and further including means for visually indicating and confirming shape deformation of the grip.

Manual implements generally incorporate a handle or related structure having a size and shape for appropriate manual grasping and manipulation of the implement during normal intended use. In one common form, the handle structure comprises an elongated rigid element having one end securely connected to the implement, such as a cooking pot or pan, a hairbrush, a tool head, etc. In another common form, the manual implement is normally grasped directly about the body thereof, such as in the case of writing and other marking instruments, baseball and softball bats, etc. In either case, a variety of improved grips have been developed in recent years for use with such manual implements, primarily to provide a relatively soft and resilient or cushioned grip structure for enhanced user comfort and improved control of the manual implement during normal use thereof.

In the past, cushioned grip structures for relatively large manual implements such as sports equipment, hand tools, cookware, and hair brushes and the like have generally been limited to relatively soft and resilient rubber or rubber-like elastomer sleeves or sleeve-like wraps mounted onto the implement handle. While such grip structures beneficially provide a degree of cushioning for improved user comfort, the relative deformation of such grip structures during normal use is inherently limited. In other words, such grip structures have generally not provided a high degree of shape deformation needed to assume a customized ergonomical shape conforming closely to the anatomical contours of an individual user's hand and/or fingers, wherein such customized shape is conducive to substantially optimized user comfort with substantially minimized user fatigue.

In relatively small manual implements such as writing instruments and the like, cushioned grip structures are similarly provided in the form of resilient elastomer sleeves and the like. In some designs, an outer resilient sleeve encloses an internal cavity which is filled with a flowable filler material such as a deformable putty or relatively viscous liquid or gel adapted to displace and thereby accommodate substantial shape deformation when the grip structure is manually grasped. See, for example, U.S. Pat. No. 5,000,599 and copending U.S. Ser. No. 10/212,248 based on prior-filed U.S. Provisional Appln. No. 60/311,923, which are incorporated by reference herein. Such grip structures can undergo substantial shape deformation to conform closely to the anatomical contours of a particular user's hand and/or fingertips for enhanced user comfort. However, in grip structures of this type, while the user can detect deformation by tactile sensation, the user cannot visually see any indication that the flowable filler material has actually displaced within the internal sleeve cavity. It is believed that visual detection of filler material displacement will enhance user comfort and satisfaction.

The present invention is directed to an improved deformable grip for use with a wide range of large and small manual implements, wherein the improved deformable grip incorporates a flowable fluid-type filler material contained within an internal chamber or cavity defined by a resilient outer grip structure such as a sleeve, and further wherein the deformable grip includes means for visually indicating and confirming displacement of the filler material in response to manual grasping of the deformable grip.

### SUMMARY OF THE INVENTION

In accordance with the invention, an improved deformable grip is provided for use with a manually grasped implement to provide a soft and resilient structure having the capacity for shape adaptation in conformance with the anatomical contours and particular grasping technique of an individual user. The deformable grip is designed to assume a custom fit configuration when the implement is grasped or gripped by the user for enhanced user comfort and control with reduced fatigue.

The deformable grip comprises an outer resilient and flexible grip structure such as an outer resilient sleeve mounted on the implement, as by mounting onto an implement body or handle, to define and substantially enclose at least one internal chamber or cavity which is filled at least partially with a flowable resilient fluid-type filler material such as a liquid or gel in a quantity to provide the outer resilient sleeve with a selected and deformable tactile feel during normal use. In addition, at least one relatively small solid or non-fluid body such as a metal or plastic ball or other selected body shape is carried within the internal chamber or cavity substantially in suspension within the flowable filler material. This solid or non-fluid body is visible from the exterior of the manual implement by forming the outer resilient sleeve and the flowable filler material from transparent or partially transparent materials.

In use, when the outer resilient sleeve is manually grasped in a normal manner, tactile pressure applied to the sleeve causes the flowable filler material within the internal chamber or cavity to displace in a manner to accommodate a customized shape adaptation in conforming to the specific anatomical contours and particular grasping technique of an individual user. Such shape deformation of the outer sleeve is accompanied by movement of the solid or non-fluid body within the internal chamber or cavity, wherein such displacement is visually observable from the exterior of the implement through the transparent sleeve and flowable filler material. This movement of the solid or non-fluid body provides visual indication and confirmation of displacement of the flowable filler material and resultant shape deformation of the resilient sleeve.

Other features and advantages of the invention will become more apparent from the following detailed description, taken in conjunction with the accompanying drawings which illustrate, by way of example, the principles of the invention.

### BRIEF DESCRIPTION OF THE DRAWINGS

The accompanying drawings illustrate the invention. In such drawings:

FIG. 1 is a perspective view illustrating a manual implement in the form of a writing instrument incorporating an improved deformable grip constructed in accordance with the present invention;

FIG. 2 is an enlarged fragmented perspective view of a portion of the writing implement of FIG. 1, with portions broken away to reveal construction details of the deformable grip and mounting thereof onto the writing implement;

FIG. 3 is a transverse sectional view taken generally on the line 3-3 of FIG. 2; and

FIG. 4 is an enlarged and fragmented perspective view similar to FIG. 2, and illustrating fingertip pressure applied to the deformable grip during normal use of the writing implement.

### DETAILED DESCRIPTION OF THE PREFERRED EMBODIMENT

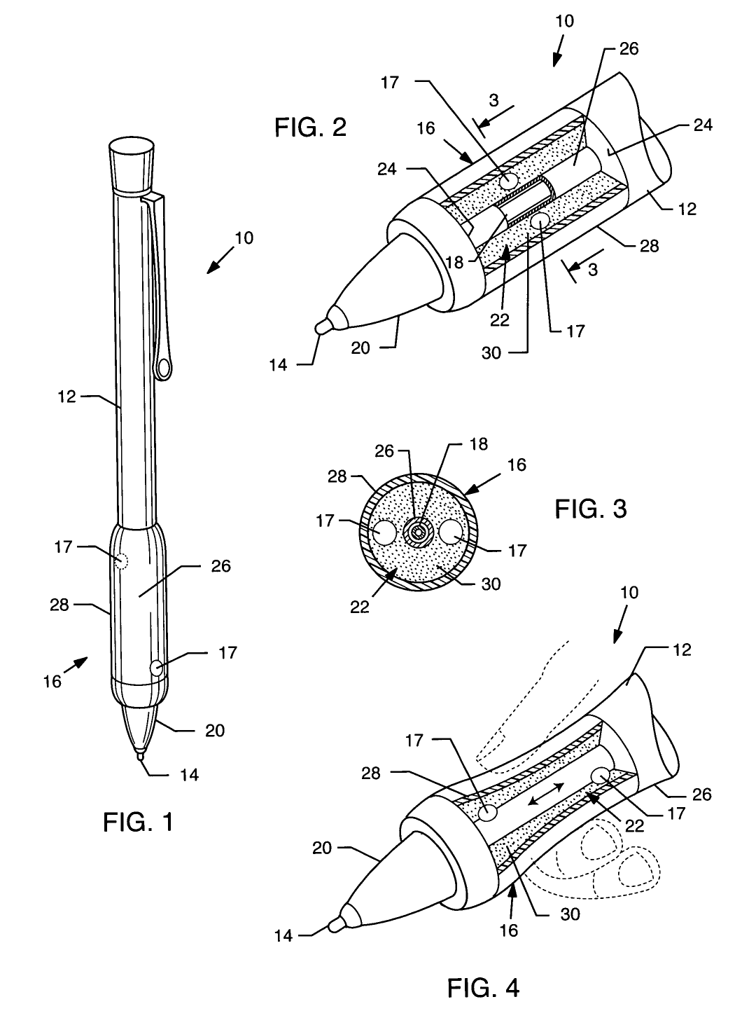

As shown in the exemplary drawings, a manual implement such as a writing implement or instrument referred to generally in FIG. 1 by the reference numeral 10 includes an elongated implement body structure 12 with a marking medium such as an exposed ball point pen tip or nib 14 at one end thereof. A deformable grip 16 is provided on the implement body 12 at a position generally at or near the end adjacent the writing tip 14, at a position and location for manual grasping during normal implement use. The deformable grip 16 resiliently changes shape in response to manual or tactile pressure when grasped to conform geometrically to the anatomical contours of a particular user, resulting in an ergonomic grip configuration that significantly enhances user comfort and reduces user fatigue. In accordance with the invention, the deformable grip 16 includes at least one internally mounted and externally visible solid or non-fluid body 17 such as a pair of balls as shown in the illustrative drawings, to provide an externally visible indication and confirmation of shape deformation of the grip 16 during use.

The deformable grip 16 of the present invention is shown in the exemplary drawings for use with the illustrative writing or marking implement 10, although persons skilled in the art will recognize and appreciate that the concept may be beneficially applied to a wide variety of manually grasped implements such as hair brushes, hand tools, sports equipment, and other manually grasped and manipulated devices having a handle, or otherwise having a body or housing geometry suitable for manual grasping during normal use. The illustrative drawings show the deformable grip 16 mounted on the writing implement 10 at a location near the marking tip 14, in a position for conventional grasping and manipulation of the writing implement during normal use thereof. In general terms, the deformable grip 16 provides a cushioned structure which advantageously conforms when grasped to a customized or personalized shape fit.

As shown, the body 12 of the writing implement 10 has an elongated and generally cylindrical configuration with a hollow interior for receiving and supporting a marking medium 18 such as a standard ball point pen cartridge. The front end of the marking medium 18 protrudes through a nose piece 20 at one end of the implement body 12 and terminates in the exposed writing tip 14, such as a floating porous ball through which ink (not shown) can flow when applied to a writing surface (also not shown) such as paper or the like.

As shown in more detail in FIGS. 2-4, the writing implement body 12 is shaped to include a generally annular recessed cavity 22 at a position at or near the nose piece 20. This recessed cavity 22 is normally defined between a pair of axially spaced shoulders 24 (FIG. 2) and surrounds a central guide tube 26 of reduced diameter through which the marking medium cartridge 18 extends. The axial length of this cavity 22 may vary in accordance with the size and style of the writing implement, with a typical length on the order of about one to two inches being suitable for most writing implement applications.

The recessed cavity 22 is enclosed by an outer cylindrical sleeve 28 of a thin rubber-based or deformable plastic or other selected resilient and deformable elastomer material. The sleeve 28 has its opposite ends suitably attached at or to the opposed shoulders 24 at the opposite ends of the cavity 22, for substantially enclosing said cavity. In accordance with one important aspect of the present invention, this outer sleeve 28 is also formed to have a transparent or at least partially transparent construction, so that the interior of the cavity 22 may be externally viewed and observed, as will be described in more detail herein.

A flowable filler material 30 is provided within the annular cavity 22, to at least partially fill the cavity. In one preferred form, this flowable filler material comprises a fluid-type substance such as a relatively viscous liquid or gel suitable for movably responding to fingertip or tactile pressure applied to the outer sleeve 28 during normal use of the manual implement. In accordance with an important feature of the invention, this flowable filler material is also formed from material that is transparent or at least partially transparent.

In addition to the flowable filler material 30, at least one of the solid or non-fluid bodies 17 such as the pair of balls shown in the illustrative drawings are also contained within the annular cavity 22, to provide an externally visible indication and confirmation of shape deformation of the grip 16 during use. More particularly, the non-fluid ball or balls 17 each have a size and shape for placement into the annular cavity 22, substantially in suspension within the flowable filler material 30. This ball or balls 17 are each visible from the exterior of the implement 10, by virtue of the transparent characteristics of the outer sleeve 28 and the filler material 30. When the implement 10 is not in use, the ball or balls 17 will tend to shift gravitationally within the cavity 22, thereby providing an externally visible indication that the ball or balls are suspended within a transparent substance, namely, the filler material 30.

When the implement 10 is manually grasped for normal use, as viewed in FIG. 4, the filler material 30 will movably displace within the cavity 22 to accommodate shape deformation of the outer sleeve 28 according to the custom anatomical contours of the user's fingertips or the like. Such shape deformation, due to the transparent character of the filler material 30, does not by itself indicate to the user that the filler material 30 has movably shifted within the cavity 22. However, such displacement of the filler material 30 is accompanied by movement or displacement of the ball or balls 17, whereby such ball movement provides an externally visible and observable indication and confirmation that the filler material 30 has undergone shape deformation.

Although the invention has been shown and described with respect to solid or non-fluid bodies 17 in the form of round balls, persons skilled in the art will recognize and appreciate that a wide variety of alternative shapes and other appearances may be used. For example, in certain applications, the solid or non-fluid body may comprise a novelty figure such as an animal or toy shape or the like, and further wherein the non-fluid body may be formed from a rigid incompressible or a soft deformable material. Bright colors may also be used to enhance the visibility thereof.

A variety of further modifications and improvements in and to the deformable grip 16 of the present invention will be apparent to those persons skilled in the art. Accordingly, no limitation on the invention is intended by way of the foregoing description and accompanying drawings, except as set forth in the appended claims.

What is claimed is:

1. A manual implement, comprising:
an implement body;
a deformable grip on said implement body and defining a grip cavity having a deformable flowable filler material therein, said deformable grip movably responding to manual pressure when said deformable grip is manually grasped;
said deformable grip and said flowable filler material each being formed from an at least partially transparent material; and
at least one motion indicator member disposed within said cavity, said motion indicator member being at least partially visible from the exterior of said cavity and movably responding within said cavity to manual grasping of said deformable grip.

2. The manual implement of claim 1 wherein said at least one motion indicator member comprises a plurality of motion indicator members disposed within said cavity.

3. The manual implement of claim 1 wherein said at least one motion indicator member is formed from a relatively soft and deformable material.

4. The manual implement of claim 1 wherein said at least one motion indicator member comprises a solid body.

5. The manual implement of claim 1 wherein said at least one motion indicator member comprises a non-fluid body.

6. The manual implement of claim 1 wherein said deformable grip comprises a deformable elastomer.

7. The manual implement of claim 1 wherein said deformable grip comprises a sleeve mounted on said implement body and cooperating therewith to define said cavity.

8. The manual implement of claim 7 wherein said at least a portion of said sleeve is at least partially transparent.

9. The manual implement of claim 1 wherein said flowable filler material comprises a liquid.

10. The manual implement of claim 1 wherein said flowable filler material comprises a gel.

11. A manual implement, comprising:
an implement body;
a deformable grip including a resilient sleeve carried by said implement body and cooperating therewith to define a grip cavity, at least a portion of said sleeve being at least partially transparent;
a transparent flowable filler material carried within said grip cavity, whereby said sleeve movably responds to manual pressure when manually grasped; and
at least one motion indicator member disposed within said grip cavity, said motion indicator member being at least partially visible from the exterior of said cavity and movably responding within said cavity to manual grasping of said sleeve.

12. The manual implement of claim 11 wherein said at least one motion indicator member comprises a plurality of motion indicator members disposed within said cavity.

13. The manual implement of claim 11 wherein said sleeve comprises a deformable elastomer.

14. The manual implement of claim 11 wherein said flowable filler material comprises a liquid or gel.

15. A deformable grip for a manual implement, said deformable grip comprising:
a deformable member enclosing at least an outer portion of a grip cavity, said deformable member being at least partially transparent;
a substantially transparent flowable filler material within said grip cavity, whereby said deformable member movably responds to manual pressure when manually grasped; and
motion indicator means disposed within said grip cavity, said motion indicator means comprising at least one body and being at least partially visible from the exterior of said grip cavity and movably responding within said grip cavity in response to manual grasping of said deformable member.

16. The deformable grip of claim 15 wherein said motion indicator means comprises a plurality of bodies disposed within said grip cavity.

17. The deformable grip of claim 15 wherein said deformable member comprises a deformable elastomer.

18. The deformable grip of claim 15 wherein said deformable member comprises a resilient sleeve.

19. The deformable grip of claim 15 wherein said flowable filler material comprises a liquid or gel.
